(19) United States
(12) Patent Application Publication
(10) Pub. No.: US 2025/0156297 A1
(43) Pub. Date: May 15, 2025

(54) SYSTEMS AND METHODS FOR MONITORING PROVIDER USER ACTIVITY

(71) Applicant: Wells Fargo Bank, N.A., San Francisco, CA (US)

(72) Inventors: Debashis Ghosh, Charlotte, NC (US); Richard Claude Robert Trent, Newton, NC (US)

(73) Assignee: Wells Fargo Bank, N.A., San Francisco, CA (US)

(21) Appl. No.: 18/507,464

(22) Filed: Nov. 13, 2023

(51) Int. Cl. G06F 11/34

(52) U.S. Cl. CPC G06F 11/3438; G06F 11/3447

(57) ABSTRACT

A computing system includes a processing circuit configured to obtain user activity data pertaining to a plurality of users enrolled in a service provided by a first provider, identify a first plurality of accounts for which one or more first users have with the first provider and a second plurality of accounts for which one or more second users have with one or more second providers, generate a plurality of datasets, identify a first set of accounts that exceed a predetermined threshold and a second set of accounts within the predetermined threshold, generate a plurality of changes to the predetermined criteria to adjust at least one of a number of accounts included in the first set of accounts or a number of accounts included in the second set of accounts, and generate and present a graphical user interface (GUI) including a plurality of elements to indicate the plurality of changes.

### TECHNICAL FIELD

The present disclosure relates generally to systems and methods for determining criteria used by providers in evaluating customers for new accounts or products.

### BACKGROUND

In a computer network environment, providers may receive information pertaining to one or more accounts for various clients or customers. The providers may monitor one or more aspects with respect to client accounts. However, providers are unable to determine criteria that other providers use when providing products to the other provider's customers.

### SUMMARY

Some arrangements relate to a method. In some arrangements, the method includes obtaining, by one or more processing circuits, user activity data pertaining to a plurality of users enrolled in a service provided by a first provider. In some arrangement, the method includes identifying, by the one or more processing circuits based on information included in the user activity data, a first plurality of accounts for which one or more first users of the plurality of users have with the first provider, and a second plurality of accounts for which one or more second users of the plurality of users have with one or more second providers. In some arrangements, the method includes generating, by the one or more processing circuits based on information associated with at least one of the first plurality of accounts or the second plurality of accounts, a plurality of datasets corresponding to information associated with at least one of the first provider or the one or more second providers. In some arrangements, the method includes identifying, by the one or more processing circuits responsive to evaluation of the plurality of datasets based on predetermined criteria, a first set of accounts of at least one of the first plurality of accounts or the second plurality of accounts that exceed a predetermined threshold, and a second set of accounts of at least one of the first plurality of accounts or the second plurality of accounts within the predetermined threshold. In some arrangements, the method includes generating, by the one or more processing circuits based on characteristics of the first set of accounts or characteristics of the second set of accounts, a plurality of changes to the predetermined criteria to adjust at least one of a number of accounts included in the first set of accounts or a number of accounts included in the second set of accounts, and generating and presenting, by the one or more processing circuits, a graphical user interface (GUI) including a plurality of elements to indicate the plurality of changes.

Some arrangements relate to a computing system. The computing system includes a processing circuit including one or more memory devices and one or more processors wherein the processing circuit is configured to obtain user activity data pertaining to a plurality of users enrolled in a service provided by a first provider. In some arrangements, the processing circuit is configured to identify, based on information included in the user activity data, a first plurality of accounts for which one or more first users of the plurality of users have with the first provider, and a second plurality of accounts for which one or more second users of the plurality of users have with one or more second providers. In some arrangements, the processing circuit is configured to generate, based on information associated with at least one the first plurality of accounts or the second plurality of accounts, a plurality of datasets corresponding to information associated with at least one of the first provider or the one or more second providers. In some arrangements, the processing circuit is configured to identify, responsive to evaluation of the plurality of datasets based on predetermined criteria, a first set of accounts of at least one of the first plurality of accounts or the second plurality of accounts that exceed a predetermined threshold, and a second set of accounts of at least one of the first plurality of accounts or the second plurality of accounts within the predetermined threshold. In some arrangements, the processing circuit is configured to generate, based on characteristics of the first set of accounts or characteristics of the second set of accounts, a plurality of changes to the predetermined criteria to adjust at least one of a number of accounts included in the first set of accounts or a number of accounts included in the second set of accounts, and generate and present a graphical user interface (GUI) including a plurality of elements to indicate the plurality of changes.

Some arrangements relate to a computer-readable storage medium (CRM) having instructions stored thereon that, when executed by a processing circuit including one or more processors, cause the processing circuit to perform operations. In some arrangements, the operations include obtaining user activity data pertaining to a plurality of users enrolled in a service provided by a first provider. In some arrangements, the operations include identifying, based on information included in the user activity data, a first plurality of accounts for which one or more first users of the plurality of users have with the first provider, and a second plurality of accounts for which one or more second users of the plurality of users have with one or more second providers. In some arrangements, the operations include generating, based on information associated with at least one of the first plurality of accounts or the second plurality of accounts, a plurality of datasets corresponding to information associated with at least one of the first provider or the one or more second providers. In some arrangements, the operations include identifying, responsive to evaluation of the plurality of datasets based on predetermined criteria, a first set of accounts of at least one of the first plurality of accounts or the second plurality of accounts that exceed a predetermined threshold, and a second set of accounts of at least one of the first plurality of accounts or the second plurality of accounts within the predetermined threshold. In some arrangements, the operations include generating, based on characteristics of the first set of accounts or characteristics of the second set of accounts, a plurality of changes to the predetermined criteria to adjust at least one of a number of accounts included in the first set of accounts or a number of accounts included in the second set of accounts, and generating and presenting a graphical user interface (GUI) including a plurality of elements to indicate the plurality of changes.

### BRIEF DESCRIPTION OF THE DRAWINGS

FIG. 1 is a block diagram of an activity modeler architecture including an analysis system, according to example embodiments.

FIG. 2 is a block diagram illustrating an example computing system suitable for use in the example embodiments described herein.

FIG. 3 is a flow diagram of a method for cross-provider activity modeling, according to example embodiments.

FIG. 4 is a block diagram of a cross-provider system included in the activity modeler architecture illustrated in FIG. 1, according to example embodiments.

FIG. 5 is a flow diagram of a method for monitoring cross-provider user activity, according to example embodiments.

### DETAILED DESCRIPTION

Referring generally to the Figures, the systems and methods described herein relate to modeling activities and performance of an entity to determine future activities. The systems and methods described herein generally relate to implementing a system that can predict future events (e.g., performance) of an entity. The system may monitor an entirety of the entity's profile (e.g., a landscape), regardless of institution means. In typical systems, a computer device (e.g., desktop computer, mobile device, smart device) can present a variety of content (e.g., within the viewpoint of the computing device) with actions that relate to an entity's performance. The systems and methods described herein generally relate to transparently providing an entity with complete knowledge of their profile, along with providing future actionable activities, based on an entity's activity data, aimed at positively updating an entity's profile. The present disclosure is aimed at positively updating an entity's profile (e.g., financial profile, performance indicators) through resource allocation authorizations to determine and generate bundled resource authorization. In typical systems, the entity can be presented with a performance indicator that is days, weeks, months, or years old. Having a performance indicator that is not based on current interaction data can lead an entity to rely on the non-current performance indicator (i.e., outdated performance indicator), leading to a decision or lack of decision-making that can affect a future performance and adversely affect an entity's profile and their knowledge thereof.

The system may retrieve entity profile information (e.g., credit card accounts, loans, mortgages, saving accounts, checking accounts, etc.) and evaluate various aspects of the entity profile information. For example, the system may compare an interest rate of a first loan with an interest rate of a second loan. The system may determine, responsive to the comparisons, differences between providers (e.g., differences between banks and/or lenders). For example, the system may determine that a first provider is offering loans with an interest rate of X, and the system may determine that a second provider is offering loans with an interest rate of Y.

The system may utilize data generated while comparing various providers and/or accounts associated with the various providers to determine and/or identify criteria. For example, the system may identify underwriting criteria for various banks. As another example, the system may identify a number of new accounts that are opened over a given amount of time at the various banks. The system may evaluate the underwriting criteria based on previous, current, and/or future performance of customers and/or clients.

Accordingly, the present disclosure is directed to systems and methods for generating, providing, and presenting a real time view of a user's performance (e.g., current economic credit position, account status across providers, etc.) to generate, predict, and summarize future events. Further, the present disclosure improves data security by reducing the need to share information across providers (e.g., banks, credit providers, investment services, corporate institutions). The present disclosure also improves data privacy which often is a hurdle to overcome when providers attempt to communicate between each other. The present disclosure is aimed at improving both usability and data security, ensuring customer protected data (e.g., transaction data, financial data, account data) stays within the purview of operating providers (e.g., credit reporting agencies) while still providing insights to the entity.

Additionally, the present disclosure is directed towards improvements in existing forecasting architectures. The present disclosure enhances the precision of data analysis by using a predictive model to generate a holistic picture of a user's economic positions across providers. The predictive model of the present disclosure improves existing systems by accurately anticipating future activities and potential events (e.g., overdraft scenarios) based on a predictive model that adapts to each customer's activity and habits. The present disclosure is directed towards capabilities that go beyond providing a snapshot of the user's profile (e.g., credit score), especially within a data isolated institution, through a predictive model capable of dynamically generating predictions across providers.

Additionally, the systems and methods of the present disclosure are directed towards improvements to economic tools that are generally passive. The present disclosure provides for active systems capable of established alert thresholds and predict potential un-advantageous situations to provide an active personalized tool to reduce potential negative events associated with a customer or provider institutions. The customized system of the present disclosure is individualist and provides improvements to data validation and extraction processes. Additionally, the user specific graphical user interfaces provide the end user with control over how the content is executed, providing an improved user interface. Therefore, aspects of the present disclosure also address problems in content presentation by providing improved presentation technology for the presentation of content on particular computer devices. In particular, the present disclosure addresses the technical challenges in interfacing by presenting personalized content. In one example, one or more process circuits of the electronic devices can determine the amount of use of each task and indicators over a period of time and determine how much memory has been allocated to various tasks and indicators over a period of time (e.g., analysis system tracking memory usage for incoming exchanges and their effects on performance indicators over a period of a time) such that adjustments to the user interface can be done in real-time (e.g., end high memory usage processes, allocate more memory usage to certain processes, enable more memory for usage, and so on).

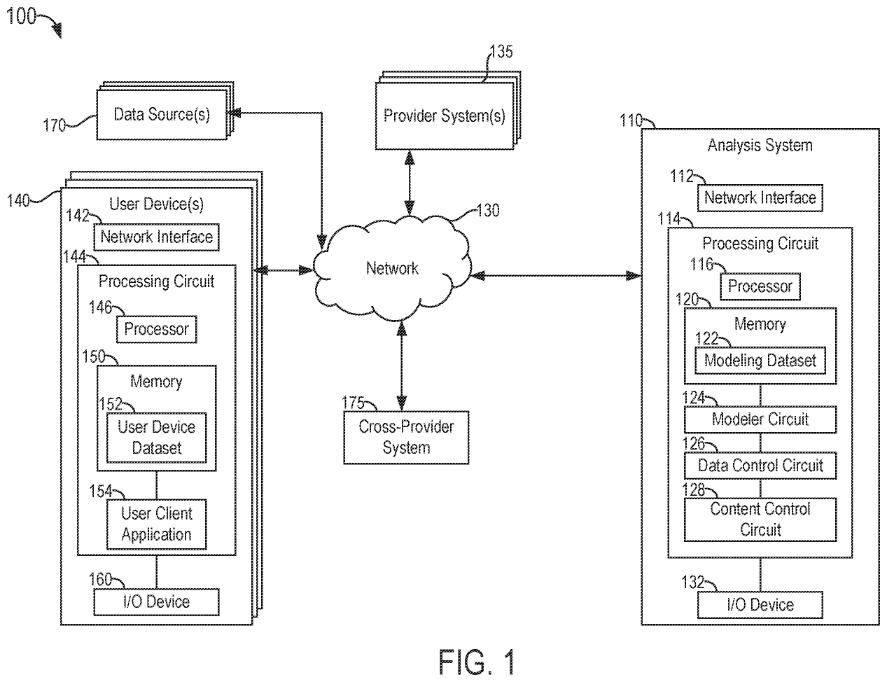

Referring to FIG. 1, a block diagram of an activity modeler architecture 100 including an analysis system 110 is shown, according to potential embodiments. The analysis system 110 can be associated with a provider, such as a service provider, bank, or FI. The activity modeler architecture 100 further includes one or more user devices (e.g., user device 140), one or more data sources (e.g., data source 170), an analysis system 110 (e.g., a computing system of a location of the FI), and a cross-provider system 175. In some embodiments, the analysis system 110, user device 140 (as well as any additional user devices), and data source 170 are communicatively coupled. In some embodiments, the components of the activity modeler architecture 100 may be communicably and operatively coupled to each other over a network, such as network 130, that permits the direct or indirect exchange of data, values, instructions, messages, and the like (represented by the double-headed arrows in FIG. 1). The network 130 may include one or more of a cellular network, the Internet, Wi-Fi™, Wi-Max™, a proprietary provider network, a proprietary retail or service provider network, and/or any other kind of wireless or wired network.

Each system or device in activity modeler architecture 100 may include one or more processors, memories, and network interfaces (sometimes referred to herein as a “network circuit”). The memory may store programming logic that, when executed by the processor, controls the operation of the corresponding computing system or device. The memory may also store data in databases. For example, memory 120 may store programming logic that when executed by processor 116 within processing circuit 114, causes modeling dataset 122 to update or model information from a user's account with information received from a user device 140 and/or data sources 170. The various components of devices in activity modeler architecture 100 may be implemented via hardware (e.g., circuitry), software (e.g., executable code), or any combination thereof. Devices and components in FIG. 1 can be added, deleted, integrated, separated, and/or rearranged in various embodiments of the disclosure.

The analysis system 110 may be operated by a provider, such as an entity, a consultant, a retailer, a service provider (e.g., a financial institution or bank). The analysis system 110 includes a network interface 112 and can be structured and used to establish connections with other computing systems and devices (e.g., the user devices 140, the data source 170, etc.) via the network 130. The network interface 112 includes program logic that facilitates connection of the analysis system 110 to the network 130. For example, the network interface 112 may include any combination of a wireless network transceiver (e.g., a cellular modem, a Bluetooth™ transceiver, a WiFi™ transceiver, etc.) and/or a wired network transceiver (e.g., an Ethernet transceiver). In some arrangements, the network interface 112 includes the hardware (e.g., processor, memory, and so on) and machine-readable media sufficient to support communication over multiple channels of data communication. Further, in some arrangements, the network interface 112 includes cryptography capabilities to establish a secure or relatively secure communication session in which data communicated over the session is encrypted. In various embodiments, the activity modeler architecture 100 can adapt to network traffic needs by compressing content, by any computing device described herein, and sending it (e.g., via network 130) to various other computing devices, by adjusting security filters to remove junk traffic off network 130 (e.g., by monitoring packets), and so on. While described with regards to a provider, the analysis system 110 may be used in other scenarios. For example, the analysis system 110 may be used at a car dealership or car rental company, a hotel, a booking agent, and/or a medical office.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The components of FIG. 1 are meant for illustrative purposes only and should not be regarded as limiting in any manner. The memory 120 may be one or more devices (e.g., RAM, ROM, Flash memory, hard disk storage) for storing data and/or computer code for completing and/or facilitating the various processes described herein. The memory 120 may be or include non-transient volatile memory, non-volatile memory, and non-transitory computer storage media. Memory 120 may include database components, object code components, script components, or any other type of information structure for supporting the various activities and information structures described herein. Memory 120 may be communicably coupled to the processor 116 and include computer code or instructions for executing one or more processes described herein. The processor 116 may be implemented as one or more application specific integrated circuits (ASICs), field programmable gate arrays (FPGAs), a group of processing components, or other suitable electronic processing components. As such, the analysis system 110 is configured to run a variety of application programs and store associated data in a database of the memory 120 (e.g., modeling dataset 122). One such application may be to provide data to the modeler circuit 124, data control circuit 126, and content control circuit 128.

As used herein, “activity data” refers to data of an account and/or identifier relating to the economic or financial position of the entity. Activity data could refer to bill payments, payment history, opening credit lines, amount owed, length of credit history, credit mix, new credit, closing credit lines, or debt repayment across at least one provider and includes at least one of performance indicator data, historical exchange settlements, and account exchange information. In some embodiments, performance indicators correspond to a user's credit history and include at least one of a user's performance indicator data, historical exchange settlements, account exchange information across at least one provider, and other similar data. “Future activity data” refers to the above defined activity data that may occur in the future.

As used herein, a “performance indicator” refers to any measurement of user performance, often financially related. For example, a performance indicator could refer to credit score, credit report, debt-to-income ratio (DTI), payment history, income stability, debt utilization ratio, savings and asset levels, among other performance standards. In particular, a performance indicator can be construed as a snapshot or representation of the financial health of an entity or account at a given point in time. It's a multidimensional concept that encapsulates various economic indicators such as the entity's solvency (its ability to meet long-term obligations), assets (what it owns), liabilities (what it owes), and other related financial markers. Often, performance indicators have set rules for determining performance based on activity data. For example, one type of performance indicator, credit score is based on the activity data of amounts owed, new credit, length of credit history, payment history, and credit mix.

As used herein, a “user data structure” refers to a framework employed to arrange and store user data. Depending on the nature of data and the requirements of operations performed on it, various data structures like a Merkle tree, linked list, hash table, graph, or an array could be employed.

As user herein, an “actionable activity” refers to any activity that can be taken by a provider in response to activity data. For example, an actionable activity can refer to making a payment, automating future payments, remediating past payments, remediating past missed payments, consolidating lines of credit, generating a reward, performing a fraud check on exchanges, generating a notification, registering a new account or line of credit, paying a minimum, or other provider activities.

The processing circuit 114, interacting with the memory 120 can store a variety of data in the modeling dataset 122, according to some embodiments, including user data structures. The modeler circuit 124 can use data stored in the modeling dataset 122 and other gathered data to generate a user data structure which could then be stored in the modeling dataset 122. The modeling dataset 122 may also be configured to store a user data structure which can include updated personal information for customer accounts associated with the provider (e.g., the FI). For example, the modeling dataset 122 can store personal user information that models account activity affecting performance indicators, such as previous exchanges for loans, bills, credit card payments, payments to other accounts either owned or not owned by the user, among other exchanges. The modeling dataset can store other personal user information used in modeling activity such as name, age, gender, address, education, occupation, etc., customer preferences, such as notification preferences, security preferences, etc., and authentication information, such as customer passwords, biometric data for the customer, geometric information (e.g., latitude, longitude), etc. In some embodiments, the modeling dataset 122 includes a token vault that stores an associated customer token and/or device token for each customer account. The modeling dataset 122 may further be configured to store financial data for each customer account, such as past transactions, different provider account information (e.g., balances, debt, type of account, etc.), investments, loans, mortgages, and so on.

In some embodiments, the memory 120 and modeling dataset 122 may be communicably coupled to the modeler circuit 124, data control circuit 126, or content control circuit 128. The modeler circuit 124 implements modeling operations of the analysis system 110. In various arrangements, the modeler circuit 124 can be configured to receive a plurality of data from a plurality of data sources (e.g., memory 120, modeling dataset 122, data control circuit 126, content control circuit 128, user device 140, data source 170) via one or more data channels (e.g., over network 130). Each data channel may include a network connection (e.g., wired, wireless, cloud) between the devices or systems and the analysis system 110. For example, the modeler circuit 124 could query the memory 120 for data of the modeling dataset 122 and use the modeling data to generate a user data structure that models user activity data and one or more performance indicators (e.g., the modeling dataset that includes items such as past bills can be used by the modeling circuit to create a user data structure that resembles an up to date credit score).

The modeler circuit 124 can be further configured to receive new activity data or an updated performance indicator from input/output device 132 and/or I/O device 132 of the analysis system 110. For example, the modeler circuit 124 may be configured to continuously monitor and receive new information from a user device 140, data source 170, or provider system 135 via the network 130 and determine the effect on the one or more performance indicators. New data can affect the modeling dataset 122 and thereon after the modeler circuit 124, data control circuit 126, content control circuit 128, and other parts of the analysis system 110. For example, a user could pay off a previous debt after their activity data has already been sent to the analysis system 110. A source (e.g., user device 140, data source 170, or provider system 135) may then send the activity data, (e.g., debt payment) to the analysis system. Because debt payment is a significant factor affecting the performance indicator of credit score, not only would the modeling dataset 122 be updated, but the modeler circuit 124 would significantly update the user data structure. For example, the debt payment could cause the modeler circuit to significantly change the credit capabilities of the user, which affects what products and actionable activities are available to the user.

For example, the modeler circuit 124 can be configured to model user activity data and the one or more performance indicators to generate a user data structure. In some embodiments, the data structure created by the modeler circuit 124 corresponds to at least one of past, current, and/or future activity of the user. The modeler circuit 124 can continuously update the user data structure based on continuously updated the user activity data received by the analysis system 110 from various sources (e.g., user device 140, data sources 170, or provider systems 135). Because many of the performance indicators are proportional to changes in activity data, the modeler circuit can continuously update the user data structure in response to updated user activity data. For example, if a user were to open a new line of credit, the modeler circuit 124 could determine the effect of the new line of credit has on the user data structure to determine what products the provider could offer. For example, the modeler circuit could update the user data structure and determine that the new line of credit could allow the customer to consolidate other lines of credit into the new one, consolidate bill payments into the new credit line, or simply update the user data structure to note a new line of credit and its effects on other performance indicators, among other capabilities.

In some embodiments, the modeler circuit 124 can determine that new data in the modeling dataset 122 contains a discrepancy or violation. For example, the modeling dataset could receive new activity data or performance indicators including an updated credit report on the user. When the modeler circuit 124 uses the updated activity data to create an updated user data structure, the modeler could flag a discrepancy in the updated activity. For example, the credit report could include a false line of credit that the previous activity data did not include. The modeler circuit 124 could then model the user activity data to create a user data structure that denotes a false line of credit to be addressed by the data control circuit 126 or content control circuit 128.

In some embodiments, the modeler circuit 124 can model activity data to determine information such as how performance indicators are affected based off the data in the memory 120 and rules on how activity data and performance indicators affect a user data structure, future activities, and performance indicators, among other. The modeler circuit 124 can be configured to perform data fusion operations, including operations to generate and/or aggregate various data structures stored in memory 120. For example, the modeler circuit 124 can be configured to aggregate data stored in memory 120, such as aggregating the total amount of lines of credit open by a user for purposes of determining if a new line of credit could be opened or if the user would benefit from consolidating lines of credit. The data may be a user data structure associated with a specific user entity and include various data from a plurality of data channels.

In some embodiments, the modeler circuit 124 can determine that the user data structure includes previous activity of the user causing an update in one or more performance indicators. In some embodiments, the modeler circuit can provide information to the data control circuit 126 and content control circuit 128. For example, if a user were to repeatedly pay a number of bills on time for an extended period of time, the modeler circuit 124 may determine an increase in a user's performance indicator of credit score. The modeler circuit 124 can determine through its modeling that the bill payments warrant an increase in credit score and indicate to the data control circuit 126 or content control circuit 128 to update the GUI to present the update to the user.

In some embodiments, the modeler circuit 124 can determine, based on the data in memory 120, that a user's activity data, if altered in a future scenario, could provide an additional benefit to one or more of the performance indicators. In some embodiments, the modeler circuit 124 can identify a plurality of resource allocation authorizations associated with at least two provider computing systems (e.g., provider systems 135, data sources 170). In some embodiments, the plurality of resource allocation authorizations may correspond to at least one authorization parameter to utilize one or more resources of each of the provider systems (e.g., provider systems 135, data sources 170). In some embodiments, the modeler circuit 124 could further determine a bundled resource authorization to offer the user to be indicated to the user by the data control circuit 126 or content control circuit 128. In some embodiments, the bundled resource authorization includes the modeler circuit 124 generating one or more new authorization parameters based on the authorization parameters of each of the provider computing systems. For example, the modeler circuit 124 could determine, based on data in the memory 120 that a user has lines of credit open with multiple providers or bills being paid at multiple providers. If the lines or credits or bill payments satisfy predetermined rules for configuring future activity such as offering a bundled line of credit, then the modeler circuit 124 may configure a bundling scenario and indicate to the data control circuit 126 or content control circuit 128 to update the GUI to present the scenario to the user.

In some embodiments, the modeler circuit 124 can determine one or more common parameters across the plurality of resource allocation authorizations and can determine one or more conflicting parameters across the plurality of resource allocation authorizations. In some embodiments, the modeler circuit 124 can model the one or more common parameters and the one or more conflicting parameters to generate the one or more new authorization parameters. In some embodiments, modeling includes combining one or more common parameters and resolving the one or more conflicting parameters based on a set of predefined rules or user-defined preferences. For example, if a user has lines of credit open at multiple institutions, the processing circuit 114 could combine the lines of credit together into one line. Further, the processing circuit could identify if the different institutions have conflicting parameters such as associating a different credit score with the user and resolving the discrepancy. In some embodiments, consolidating the plurality of resource allocation authorizations into the bundled resource authorization is done to provide a positive impact on the one or more performance indicators. For example, the processing circuit 114 and the modeler circuit 124 may only provide a consolidation of bundled lines of credit if consolidation positively affects a user's credit score. In some embodiments, the bundled resource authorization includes an estimated elimination period for satisfying one or more obligations associated with the plurality of resource allocation authorizations. For example, the processing circuit 114 may provide for an education aspect such as providing an estimated payoff time to pay off debt from one or more of the user's credit lines.

In some embodiments, the processing circuit 114 can monitor the one or more performance indicators based on continuously receiving new information from a user device of the user (e.g., user device 140), one or more data sources (e.g., data source 170), and one or more provider systems (e.g., provider system 135). For example, the processor can determine a user plan based on the user activity data, such as a plan aimed to increase a credit score. The processing circuit 114 will then continuously monitor user activity relating to the plan, and the modeler circuit 124 can continuously monitor user activity to update the user data structure. In some embodiments, the processing circuit 114 can determine a discrepancy in the user activity data or performance indicators based on previous activity of the user. For example, a credit report could include a line of credit that the customer did not have. In some embodiments, the processing circuit 114 can determine a violation associated with the actionable activity based on a comparison between user activity data or a performance indicator and a desired action for increasing the performance indicator. In some embodiments, the comparison identifies an activity counter to the desired action. For example, the user may pay a bill late after having a plan to increase their credit score. In some embodiments, the processing circuit 114, through the data control circuit 126 or content control circuit 128, can remediate the discrepancy or violation by at least one of presenting an alert on the GUI comprising remediation instructions for the user, or establishing, via an alert on the GUI, a communication session with an external system associated with the activity counter to the desired action. In some embodiments, the processing circuit can additionally update the external system to remove the activity counter to the desired action or initiating an exchange between an account of the user and the external system. For example, in response to the bill being paid late, the system could contact the company that allowed payment to be made late, contact a credit card company to close a new account, or initiate a payment transaction to address a late payment, among other responses.

In some embodiments, the processing circuit 114 and modeler circuit 124 can determine one or more characteristics of the user data structure causing the update to the one or more performance indicators and generate a plan associated with at least one different characteristic to cause an increase to the one or more performance indicators. In some embodiments, in response to the user performing the at least one different characteristic, the processing circuit 114, through the content control circuit 128, can provide and present a reward in the GUI. In some embodiments, the reward enables another feature of the GUI. For example, the processing circuit 114 can identify financial behavior of a user such as their habits for budgeting, saving, investing, spending habits, debt management, financial goal setting, financial planning, tracking expenses, risk management, or financial education, among other habits. For example, the processor can determine when the user is more likely to miss a bill payment and can further generate a plan such as adding funds to a bill payment pool in order to pay all bills on time and further increase credit. After implementing the plan and the user no longer misses bill payments, the processor 116 and content control circuit 128 can provide a reward to the user through the I/O device 132. For example, if the user follows the plan to no longer miss any payments, the reward may be access to additional financial products of the bank. Financial products of a bank could include updated or more favorable accounts, certificates of deposits, loans, credit cards, debit cards, investment services, insurance products, foreign exchange services, and online or mobile banking services, among other products.

In some embodiments, the processing circuit 114 can perform an analysis check on previous activities of the user. For example, in some embodiments, the modeler circuit 124, data control circuit 126, or content control circuit 128 could run a security verification on any previous activity received from a user device 140, data source 170, or provider system 135 via the network 130. In some embodiments, the security verification can create a security profile corresponding to any previous activity, based on factors such as origin, transaction type, transaction location, transaction amount, and more. Those skilled in the art would recognize the factors listed above are not a limiting list for determining a security profile for transactions. In some embodiments, actions that depend on the security profile of previous activities are triggered by a security threshold. According to some embodiments, previous activities are inconsistent with previous user activity data can trigger actionable events. For example, in some embodiments, when a security profile is below a security threshold, the data control circuit 126 could send instructions to the content control circuit 128 that includes sending a graphical user interface to the user device 140 with an actionable element and at least one message associated with the triggering data.

In some embodiments, the processing circuit 114 can determine the at least one previous activity is a fraudulent activity within the user activity data and automatically remove the fraudulent activity from the user activity data. In some embodiments, the modeler circuit 124 can additionally remodel the activity data and the one or more performance indicators to generate an updated user data structure. For example, the processing circuit 114 can determine if one of a user's previous transactions is a transaction from a user's credit card that was stolen. Removing this transaction from the user's data set and remodeling the user data structure can provide for a more accurate depiction of a user's spending habits or other performance indicators.

In some embodiments, the at least one future activity of the user can be associated with a statement settlement action. In some embodiments, the processing circuit 114 or more specifically the modeler circuit can determine the statement settlement action will cause a negative account balance associated with an account of the user. In some embodiments, the processing circuit 114 can update an automatic exchange associated with the statement settlement to cause the non-negative account balance associated with the account of the user and configure a different statement settlement action to satisfy the difference between the non-negative account balance and the negative account balance. For example, through the modeling, the system can determine if the user has, or is likely to have a future bill payment. If the system determines the bill will result in a negative account balance (i.e., overdraft), the system can automatically setup another action, such as payment with a different account or payment with a credit card, among other actions, to remediate the negative balance. In some embodiments, the future activity can include a future exchange event associated with the first user, and the future exchange event can cause a change in the user data structure, and in response to a selection of the at least one actionable element, the future exchange is automated based on configuring an automatic exchange between an account of the user and an external system. For example, the future exchange event could be a bill pay, which could affect the user data structure such as the account balance for the user. If the actionable element of the GUI is to set up a future automatic payment for one or more bills, if the user accepts, then the system can automatically pay the future bills, even if the future bills are occurring through an external system such as at another FI.

In some embodiments, the data control circuit 126 can be configured to perform data fusion operations, including operations to generate and/or various data structures stored in memory 120 and used by the various circuits described herein. For example, the data manager can communicate with the user device or data sources by collect, receiving, or identifying data relevant for use by the other circuits. The data control circuit 126 can also be configured to receive a plurality of entity data. In some arrangements, the data control circuit 126 can be configured to receive data regarding the network 130 as a whole instead of data specific to particular entity. The received data that the data control circuit 126 receives can be data that analysis system 110 aggregates and/or data that the analysis system 110 receives from the data sources 170 and/or any other system described herein (e.g., provider system 135, user device 140).

The content control circuit 128 can include circuitry for storing information such as rules for offering actionable activities for customized user data structures. The content control circuit 128 can receive data for determining or displaying actionable activities to the user from any component of the activity modeler architecture 100 (e.g., receives a future action from the modeler circuit 124 affecting a performance indicator). The content control circuit 128 may additionally store this information in memory 120.

In some embodiments, the content control circuit 128 can generate content for displaying to users. The content can be selected from various resources (e.g., an update for a performance indicator sent from the data control circuit 126). The content control circuit 128 can also be structured to provide content (e.g., via a graphical user interface (GUI)) to the user device 140 over the network 130, for display within the resources. For example, the content control circuit 128 can present a GUI including actionable elements and a message associated with the actionable activity that may affect the performance indicator. The GUI can be sent via the I/O device 132 to the user device 140 through the network 130.

The content control circuit 128 can generate interfaces such as a plurality of customized dashboards. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with one or more entities such as a user data structure, performance indicators, past, current, or future exchange history, account information, multidimensional scores, actionable activities/executables, and/or others.

In certain embodiments, the analysis system 110 includes an application programming interface (API) and/or a software development kit (SDK) that facilitate the integration of other applications with the analysis system 110. For example, the analysis system 110 is configured to utilize the functionality of the user device 140 interacting with the user client application 154 through an API.

Still referring to FIG. 1, the input/output device 132 is structured to receive communications from and provide communications to users associated with the analysis system 110. The input/output device 132 is structured to exchange data, communications, instructions, etc. with an input/output component of the analysis system 110. In one embodiment, the input/output device 132 includes communication circuitry for facilitating the exchange of data, values, messages, and the like between the input/output device 132 and the components of the analysis system 110. In yet another embodiment, the input/output device 132 includes machine-readable media for facilitating the exchange of information between the input/output device and the components of the analysis system 110. In yet another embodiment, the input/output device 132 includes any combination of hardware components, communication circuitry, and machine-readable media.

In some embodiments, the input/output device 132 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output device 132 may provide an interface for the user to interact with various applications stored on the analysis system 110. For example, the input/output device 132 may include a keyboard, a keypad, a mouse, joystick, a touch screen, a microphone, a biometric device, a virtual reality headset, smart glasses, smart headsets, and the like. As another example, input/output device 132, may include, but is not limited to, a television monitor, a computer monitor, a printer, a facsimile, a speaker, and so on. As used herein, virtual reality, augmented reality, and mixed reality may each be used interchangeably, yet refer to any kind of extended reality, including virtual reality, augmented reality, and mixed reality.

The user devices 140 may each similarly include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the analysis system 110. Therefore, it should be understood that the description of the network interface 112, the processing circuit 114, and the input/output device 132 of the analysis system 110 provided above may be similarly applied to the network interface 142, the processing circuit 144, and the input/output device 160 of each of the user devices 140.

In some embodiments, the network interface 142 is similarly structured and used to establish connections with other computing systems (e.g., the analysis system 110, other user devices 140, and data sources 170) via the network 130. The network interface 142 may further include any or all of the components discussed above, with reference to the network interface 112.

The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150 (e.g., user device dataset 152). For example, the user devices 140 may be configured to run an application such as the user client application 154 that is stored in the user device dataset 152. In another example, the user devices 140 may be configured to store various user data, such as, but not limited to, personal user device information (e.g., names, addresses, phone numbers, contacts, call logs, installed applications, and so on), user device authentication information (e.g., username/password combinations, device authentication tokens, security question answers, unique client identifiers, biometric data (such as digital representations of biometrics), geographic data, social media data, application specific data, and so on), and user device provider information (e.g., token information, account numbers, account balances, available credit, credit history, exchange histories, and so on) relating to the various accounts.

Particularly, the user client application 154 can be configured to communicate with the analysis system 110. As such, the user devices 140 can be communicably coupled to the analysis system 110 (e.g., through interactions with the modeler circuit 124, data control circuit 126, and content control circuit 128), and data sources 170. The user client application 154 may therefore communicate with the analysis system 110 and data sources 170 to perform a variety of functions.

For example, the user client application 154 is similarly configured to receive user inputs (e.g., via a user interface of the user device 140) to complete interactions during a communication session with analysis system 110. For example, the user client application may be used during a communication session via an API with the analysis system to send updated user activity, such as if a company allowed a bill payment to be made late. Additionally, the user client application 154 is configured to output information to a display of user device 140 regarding information from the analysis system 110. For example, the user client application 154 is configured to communicate with a user interface to show graphics regarding how financial history of a customer affects a performance indicator such as credit score. Further, a user response to a display of user device 140 regarding information from the analysis system can send a message, task, or instruction to the analysis system 110 via the network 130 that allows for the modeling dataset 122, modeler circuit 124, data control circuit 126, and content control circuit to be altered or updated.

The user client application 154 is further configured communicate with the analysis system 110 to allow a user associated with the various user devices 140 to update account information and/or provide feedback during a communication session based on content from the modeler circuit 124, data control circuit 126, or content control circuit 128 via the input/output device 132. The user client application 154 may also be structured to allow the user devices 140 to retrieve and submit documents, forms, account information for other providers, and/or any type of necessary information to and/or from analysis system 110 during an established session, as required to complete communication session for performance indicator-based analysis. In some embodiments, the user client application 154 may be configured to temporarily store the various documents, forms, and/or necessary information, which may then be selectively transmitted to the analysis system 110 in response to a user input (e.g., received via the input/output device 160).

The input/output device 160 of each user device 140 may function substantially similar to and include the same or similar components as the input/output device 132 previously described, with reference to the analysis system 110. As such, it should be understood that the description of the input/output device 132 provided above may also be applied to the input/output device 160 of each of the user devices 140. In some embodiments, the input/output device 160 of each user device 140 is similarly structured to receive communications from and provide communications to a user associated the user device 140.

The data sources 170 can provide data to the analysis system 110 and/or user device 140. In some arrangements, the data sources 170 can be structured to collect data from other devices on network 130 (e.g., user devices 140 and/or other third-party devices) and relay the collected data to the analysis system 110 and/or user device 140. In some embodiments, the analysis system 110 may request data associated with specific data stored in the data source (e.g., data sources 170). For example, in some arrangements, the data sources 170 can support a search or discovery engine for Internet-connected devices. The search or discovery engine may provide data from other providers that, when added to a user data structure (e.g., user data structure created by the modeler circuit 124 based on data from the modeling dataset 122) will cause an update to a performance indicator.

In some embodiments, the activity modeler architecture 100 can include provider systems 135. A provider system 135 can be communicated with to get additional activity data, where the provider system 135 can be banks or other credit issuers (e.g., credit card companies, consumer reporting companies, financial institutions (FI). In some arrangements, provider systems can provide data to the analysis system 110 and/or user device 140. In some arrangements, provider system 135 can be structured to collect data from other devices on the network 130 (e.g., user devices 140 and/or other third-party devices) and relay the collected data to the analysis system 110 and/or user device 140. In some embodiments the analysis system 110 may request data associated with specific data stored in the provider system (e.g., provider systems 135). For example, in some arrangements, the provider systems 135 can support a search or discovery engine for Internet-connected devices. The search or discovery engine may provide data from other providers that, when added to a user data structure (e.g., user data structure created by the modeler circuit 124 based on data from the modeling dataset 122) will cause an update to a performance indicator.

In some embodiments, the provider system 135 can serve as a basis for the analysis system 110 to provide resource allocation authorizations. For example, a provider system (e.g., provider system 135) can provide user activity data to the analysis system 110. The processing circuit 114 can produce resource allocation authorizations based on data provided by the provider system 135. For example, the analysis system 110 could determine, based on data sent from the provider system 135, a user is eligible for a line of credit or bundled credit system. The analysis system 110 could produce a bundled resource authorization that includes new authorization parameters based on the authorization parameters of the provider systems 135.

In some embodiments, the cross-provider system 175 may include components, circuitry, devices, hardware, and/or devices similar to that of at least one of the various systems, devices, and/or components described herein. For example, the cross-provider system 175 may include the processing circuit 114. As another example, the cross-provider system 175 may include circuitry similar to that of the processing circuit 114. In some embodiments, the cross-provider system 175 may perform at least one of the various processes, steps, and/or functions of at least one of the various systems, devices, and/or components described herein. For example, the cross-provider system 175 may perform similar functionality to that of the analysis system 110. The cross-provider system 175 may be part of the analysis system 110 or the analysis system 110 may be part of the cross-provider system 175. As another example, the cross-provider system 175 and the analysis system 110 may be combined and/or adjoined into a single system.

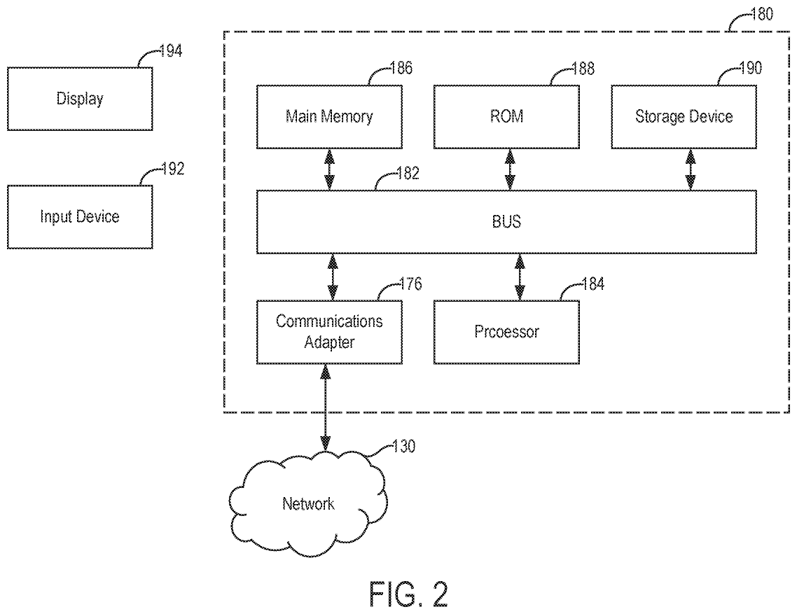

FIG. 2 illustrates a depiction of a computing system 180 that can be used, for example, to implement an activity modeler architecture 100, analysis system 110, user device 140, and/or various other example systems described in the present disclosure. The computing system 180 includes a bus 182 or other communication component for communicating information and a processor 184 coupled to the bus 182 for processing information. The computing system 180 also includes main memory 186, such as a random-access memory (RAM) or other dynamic storage device, coupled to the bus 182 for storing information, and instructions to be executed by the processor 164. Main memory 186 can also be used for storing position information, temporary variables, or other intermediate information during execution of instructions by the processor 164. The computing system 180 may further include a read only memory (ROM) 168 or other static storage device coupled to the bus 182 for storing static information and instructions for the processor 184. A storage device 190, such as a solid-state device, magnetic disk, or optical disk, is coupled to the bus 182 for persistently storing information and instructions.

The computing system 180 may be coupled via the bus 182 to a display 194, such as a liquid crystal display, or active matrix display, for displaying information to a user. An input device 192, such as a keyboard including alphanumeric and other keys, may be coupled to the bus 182 for communicating information, and command selections to the processor 184. In another arrangement, the input device 192 has a touch screen display 194. The input device 192 can include any type of biometric sensor, a cursor control, such as a mouse, a trackball, or cursor direction keys, for communicating direction information and command selections to the processor 184 and for controlling cursor movement on the display 194.

In some arrangements, the computing system 180 may include a communications adapter 176, such as a networking adapter. Communications adapter 176 may be coupled to bus 182 and may be configured to enable communications with a computing or communications network (e.g., the network 130) and/or other computing systems. In various illustrative arrangements, any type of networking configuration may be achieved using communications adapter 176, such as wired (e.g., via Ethernet), wireless (e.g., via WiFi™, Bluetooth™, and so on), satellite (e.g., via GPS) pre-configured, ad-hoc, LAN, WAN, and so on.

According to various arrangements, the processes that effectuate illustrative arrangements that are described herein can be achieved by the computing system 180 in response to the processor 184 executing an arrangement of instructions contained in main memory 186. Such instructions can be read into main memory 186 from another computer-readable medium, such as the storage device 190. Execution of the arrangement of instructions contained in main memory 186 causes the computing system 180 to perform the illustrative processes described herein. One or more processors in a multi-processing arrangement may also be employed to execute the instructions contained in main memory 186. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 2, arrangements of the subject matter and the functional operations disclosed herein can be carried out using other types of digital electronic circuitry, or in computer software (e.g., application, blockchain, distributed ledger technology) embodied on a tangible medium, firmware, or hardware, including the structures disclosed in this application and their structural equivalents, or in combinations of one or more of them. Arrangements of the subject matter disclosed herein can be implemented as one or more computer programs, e.g., one or more subsystems of computer program instructions, encoded on one or more computer storage medium for execution by, or to control the operation of, a data processing apparatus. Alternatively, or in addition, the program instructions can be encoded on an artificially generated propagated signal, e.g., a machine generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 180 may include virtualized systems and/or system resources. For example, in some arrangements, the computing system 180 may be a virtual switch, virtual router, virtual host, virtual server, etc. In various arrangements, computing system 180 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

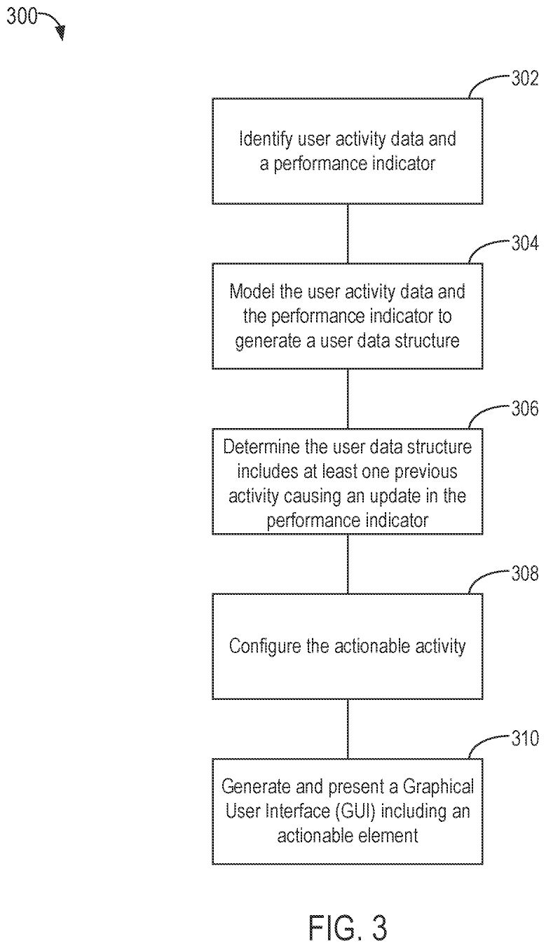

Referring now to FIG. 3, a flowchart for a method 300 of cross-provider activity modeling is shown, according to some embodiments. Analysis system 110 can be configured to perform method 300. Further, any computing device described herein can be configured to perform method 300.

In broad overview of method 300, at block 302, the one or more processing circuits (e.g., Analysis System 110 in FIG. 1) can identify user activity data and a performance indicator. At block 304, the one or more processing circuits can model user activity data and the performance indicators to generate a user data structure. At block 306, the one or more processing circuits can determine the user data structure includes at least one previous activity causing an update in the performance indicator. At block 308, the one or more processing circuits can configure the actionable activity. At block 310, the one or more processing circuits can generate and present a graphical user information including an actionable element. Additional, fewer, or different operations may be performed depending on the particular arrangement. In some embodiments, some, or all operations of method 300 may be performed by one or more processors executing on one or more computing devices, systems, or servers. In various embodiments, each operation may be re-ordered, added, removed, or repeated.

The GUI of method 300 may be provided by and/or accessible by the user client application 154 and content control circuit 128, for example. The method 300 may be performed by the analysis system 110 or the user device 140, described above pertaining to FIGS. 1 & 2. In some embodiments, method 300 begins in response to receiving, by a user device (e.g., user device 140), through a user client application (e.g., user client application 154), data from a dataset (e.g., user device dataset 152). The data can include user data, such as historical exchange settlements, performance indicator data, account exchange information across multiple providers, and activity data. In some embodiments, method begins when the analysis system 110 receives data via the network 130.

Referring now to FIG. 3 in more detail at block 302, the one or more processing circuits can identify user activity data and one or more performance indicators of a user. In some embodiments, the user activity data can refer to any and all activity of the user that might be associated with economic actions. In general, the economic actions can be broadly categorized into three types: transactional, behavioral, and informational. In some embodiments, transactional data includes, but is not limited to, all the exchanges/transactions made by the user, such as purchases, payments, fund transfers, deposits, withdrawals, etc., carried out through various channels like banking apps, credit cards, digital wallets, or other forms of online and offline transactions. This also includes transaction frequency, transaction volume, the variety of transactions, the consistency of such transactions over a period of time, etc. In some embodiments, behavioral data includes, but is not limited to, the user's interaction with financial tools and platforms. For example, how frequently the user checks their account balance, the frequency and type of inquiries about financial products or services, the response time to financial notifications, the time spent on financial educational content, etc. In some embodiments, the informational data includes, but is not limited to, the user's personal and professional details, such as age, income, occupation, education, geographical location, marital status, number of dependents, etc.

In some embodiments, the performance indicators of a user are associated with the creditworthiness of the user. This can be determined by the one or more processing circuits through various metrics such as credit score, credit history, debt-to-income ratio, and so on. In particular, a credit score (e.g., a performance indicator) can be a numerical expression based on a level analysis of a person's credit files, representing the creditworthiness of an individual. Related scores (e.g., additional performance indicators) could include alternative credit scores, which can be identified or calculated using non-traditional data like utility bill payments, rental payments, or social media activity. Additionally, performance indicators can include a bankruptcy risk score, which predicts the probability of a user declaring bankruptcy, and a fraud score, which indicates the likelihood of a user committing fraudulent activity.

Still referring to block 302, the process of identifying user activity data and performance indicators can encompass data acquisition, data cleaning, and data classification, executed by the processing circuits. It should be understood one or more of the described steps could be skipped or altered based on the received data. In some embodiments, identifying can include data acquisition by collecting raw data from various sources (e.g., user devices 140, data sources 170, provider systems 135). For example, transactional data can be acquired from the provider systems 135 that recorded the transactions made by the user. Behavioral data can be collected from digital platforms like banking apps or websites (e.g., data sources 170) where the user's interactions are tracked. Informational data can be obtained from user profiles in provider systems 135, or sometimes directly from users via an application of the user device 140. Performance indicators can be sourced from provider systems 135 (e.g., credit bureaus) that provide credit scores, credit histories, and other related metrics. Alternative data sources such as utility companies or social media platforms might also be used for alternative performance indicators.

In some embodiments, once the raw data is acquired, the processing circuits can clean and prepare the data for modeling (e.g., block 304). The processing circuits can clean or scrub the raw data by executing a series of actions to detect and rectify errors, inconsistencies, and inaccuracies within the data. In particular, cleaning could include handling missing or incomplete data, correcting inaccuracies, identifying and filtering outliers, and standardizing data formats. For example, transactional data sourced from different banks might be in different formats or currencies and would need to be standardized. In another example, data cleaning may include ensuring that credit scores from different credit bureaus are comparable by aligning them to a standard scale. In some embodiments, data cleaning can include addressing discrepancies in informational data. For example, if a user has multiple accounts across different banks or financial institutions, they might have provided slightly different personal information in each account, like different phone numbers or addresses. In such cases, the processing circuits can identify these discrepancies, verify the correct information, and standardize the user's personal information across all data sources. In another example, cleaning the behavioral data might involve filtering out irrelevant or misleading activities. In this example, a user might have accidentally clicked on a financial product or service multiple times without any real intention of using it. These accidental clicks could skew the user's behavioral profile and lead to inaccurate analyses. Therefore, the processing circuits could identify such anomalies and filter them out, ensuring the behavioral data accurately represents the user's genuine financial behavior and interests.

In some embodiments, the processing circuits can execute data classification to organize the cleaned data into predefined categories based on certain criteria. Data classification can include tagging and categorizing the data points to facilitate their storage, retrieval, and analysis. Each data point may be labeled with metadata that describes its attributes, such as its source, type, and other characteristics. For example, transactional data might be classified based on the type of transaction (e.g., a purchase, deposit, or withdrawal), the method used (e.g., credit card, debit card, or bank transfer), and the sector or category of expenditure (e.g., groceries, utilities, or entertainment). The other activity data, such as performance indicators, could be classified based on the type of score (e.g., credit score, bankruptcy risk score, or fraud score) and the source of the score (e.g., which credit bureau it came from). In some embodiments, the processing circuits can classify behavioral data based on the user's interactions with different financial platforms or tools. For example, data related to the user's use of a banking app could be classified based on actions such as checking account balance, making transactions, reading financial advice, or setting budgeting goals. These actions can further be classified based on attributes like frequency, duration, and time of activity. In another example, informational data could be classified based on demographic or socio-economic factors. This may include attributes such as age, income level, education, employment status, geographical location, and so on. For example, income data can be classified into different income brackets, education data can be classified based on the highest degree obtained, and geographical data can be classified by city, state, or country.

At block 304, the one or more processing circuits can model the user activity data and the one or more performance indicators to generate a user data structure, wherein the user data structure corresponds to at least one future activity of the user. In some embodiments, the process of modeling can include using techniques such as machine learning, statistical analysis, and pattern recognition to establish relationships between different data points and predict future outcomes based on those relationships. In some embodiments, modeling can begin with the selection of an appropriate model based on the type of data and the specific predictions that need to be made. For example, linear regression models might be selected by the processing circuits for predicting continuous outcomes such as the amount a user might spend on their credit card, while logistic regression models might be selected for predicting binary outcomes such as whether a user will make a car loan payment on time or not. It should be understood that the term modeling herein encompasses a wide range of techniques and approaches aimed at understanding patterns within data and predicting future outcomes. This could include anything from statistical methods and rule-based systems to machine learning algorithms, depending on the nature of the data and the specific predictions to be made by the processing circuits.

In some embodiments, the model parameters can be trained and optimized using the cleaned, classified, and linked user activity data and performance indicators. This training process can include using algorithms to adjust the model parameters such that the error between the model's predictions and the actual outcomes is minimized. The modeling process can also include feature engineering, which is the process of creating new features or modifying existing ones to improve the model's predictive power. For example, instead of using raw transaction amounts, a feature representing the average transaction amount over a certain period might be more predictive of a user's future economic activity.

Once the model is trained and optimized, the processing circuits can use the model to generate a user data structure that corresponds to future activities of the user. This user data structure could be a mathematical representation, a decision tree, a set of rules, or any other structure that captures the relationships between different data points and can be used to make predictions about future activities. In some embodiments, the user data structure can then be used to predict a wide range of future economic activities associated with a line of credit, such as paying a credit card bill, making a car loan payment, applying for a new loan, or even defaulting on a loan. Over time, as more user activity data and performance indicators are collected, the model can be retrained and updated to reflect the most recent patterns in the data. Moreover, the modeling process can include various safeguards to ensure privacy and security of user data (e.g., anonymizing the data).

In some embodiments, the processing circuits can use rule-based systems to model the user activity data and performance indicators. Rule-based systems can be where predefined rules are created by the processing circuits (or domain experts) to infer outcomes based on given conditions. For example, if a user consistently makes credit card payments in full before the due date, a rule might state that the user is likely to do the same in the future. This rule can then be applied to the user's data to predict their future activity of making a credit card payment. In some embodiments, the processing circuits can use statistical methods for modeling. This can involve simple approaches like time series analysis or trend analysis. For instance, time series analysis can be used to identify patterns in the user's past activity data, such as seasonal trends, cyclical patterns, or overall growth trends. If a user consistently increases their credit card spending during the holiday season, time series analysis can identify this pattern and predict a similar increase for the next holiday season. Trend analysis, on the other hand, can be used to identify long-term changes in the user's activity data. For example, if the user's credit score has been steadily improving over several years, trend analysis can project this trend into the future and predict a continued improvement in the credit score. While these methods may not be as powerful as machine learning for complex datasets, they can provide robust and interpretable predictions for relatively simple patterns in the data.

Accordingly, the processing circuits can use a predictive modeling approach to anticipate upcoming financial obligations for a user, including obligations across a diverse range of financial products such as credit cards, mortgages, loans, and others. Additionally, the modelling approach operates agnostically of the financial institution providing the service, offering an integrated and full view of a user's financial commitments. Furthermore, the predictive modeling approach executed by the processing circuits can detect seasonal or event-based patterns in the user's spending and behaviors (sometimes referred to herein as “characteristics”). If, for example, the user typically increases credit card spending during holiday seasons, the model can anticipate higher bill amounts during these periods.

Referring now to FIG. 3 in more detail at block 306, the one or more processing circuits (e.g., Analysis system 110 in FIG. 1) can determine the user data structure includes at least one previous activity causing an update in the performance indicator. In some embodiments, the process of modeling can include using techniques such as machine learning, statistical analysis, and pattern recognition to determine a previous activity within the use data structure causes an update in the performance indicator. In some embodiments, a previous activity can include any and all user activity data associated with their past economic actions compiled, cleaned, and residing as components of the user data structure. It should be understood that determining the user data structure includes at least one previous activity causing an update in the performance indicator encompasses a wide range of techniques and approaches aimed at understanding patterns within data and their effects on various outputs. For example, performance indicators (e.g., credit score, credit history, debt-to-income ratio, and so on) often have set rules on how economic actions (e.g., previously defined transactional, behavioral, and informational data) affect said performance indicators. In some embodiments, having cross-platform data consolidated in a user data structure allows the analysis system to run statistical models on how previous activity causes an update in performance indicators.

In some embodiments, having consolidated previous activity allows for the analysis system 110 to engage in projected evolution of performance indicators, a task often performed by third-party institutions. Traditionally performance indicator analysis (e.g., credit score) and the set rules on how they are affected lead to rule-based analysis systems such as projected evolution and regression analysis. Projected evolution involves project the future will evolve in a certain way based on past events. Regression analysis uses statistical regression models to analyze the relationship between past events and predict future changes based on those relationships. Relating to performance indicator analysis, using credit score as an example, projected evolution allows for taking into account a person's past transactions to assess their creditworthiness and predict future credit behavior. Credit score is generally based on factors such as payment history, amount owed, new credit, length of credit history, and credit mix. Using these statistical models allows the analysis system to determine if any of their previous activity causes an update in the performance indicators. For example, data provided by provider systems (e.g., provider systems 135) can allow the method to identify resource allocation authorizations associated with the provider systems 135. For example, data a credit provider such as a separate financial institution in which a user associates with may provide the analysis system with data regarding user behavior. At block 306, the analysis system may determine when a bundled resource authorization (e.g., line of credit, consolidated credit line) is available to generate for the user. The method at block 306 may determine lines of credit across multiple provider systems and generate new authorization parameters based on authorization parameters of provider systems. In some embodiments, where common parameters or conflicting parameters (e.g., payment transactions, bill pay) exist across the plurality of resource allocation authorizations, the method at block 306 may model the common parameters and conflicting parameters to generate the new authorization parameters. In some embodiments, the modeling includes combining the common parameters and conflicting parameters based on a set of predefined rules or user-defined preferences. For example, because credit score is based on a predetermined set of rules, the method at block 306 may determine which previous user activity (e.g., user behavior, transactional data), would cause an update in credit score.

Still referring to block 306 of FIG. 3 in more detail, the method can determine other activity causing an update in a performance indicator. In some embodiments, after the data has been cleaned and modeled by the processing circuits (e.g., block 304), the method at block 306 monitors the user activity data and the performance indicators. The monitored activity can be a process continuously receiving new information from a user device of the user (e.g., user device 140) and one or more data sources (e.g., data source 170, provider system 135). In some embodiments, a previous activity causing an update in the performance indicators could be a discrepancy or violation in the user activity data. For example, the modeling at block 304 and following statistical analysis could identify a violation such as an overdraft violation or fraud violation. Through trained model parameters, such as trend analysis, adaptive learning, alert generation, the method at block 306 can determine when there is a violation of the actionable activity based on a comparison between the user activity data and the one or more performance indicators, and determine a desired action for increasing the performance indicators, when the comparison identifies an activity counter to the desired action. For example, the analysis system (e.g., analysis system 110) can analyze relationships and connection between entities, accounts, devices, or IP addresses for the behavioral data received. For example, if an IP address from a user's past transaction does not match the IP address for the same transaction made a month prior, a discrepancy is identified, and a violation is sent through the analysis system to generate an actionable activity at block 308 such as challenging the transaction on a basis of fraud.

Still referring to block 306 of FIG. 3 in more detail, the method can determine other activity causing an update in a performance indicator. For example, in some embodiments, if the system determines previous activity involves a repetitive bill pay on the same day of every month, but the user does not have sufficient funds for the future activity of paying the bill in the future, the method at block 306 can predict an overdraft and configure an overdraft warning at block 308. Additionally, the method at block 306 could determine the account holds a low balance for an aggregate number of bills that are predicted to be due across all of the user's accounts, including accounts from a different provider system, and again configure an activity at block 308 to alert the user.

Referring now to FIG. 3 in more detail at block 308, the one or more processing circuits can configure the actionable activity. In some embodiments, the actionable activity corresponds to the future activity of the user. In some embodiments, the actionable activity is below a user threshold. In some embodiments, configuring the actionable activity is in response to determining an actionable activity is associated with the at least one previous activity. In some embodiments, configuring the actionable activity is based on the possible actionable activities determined from any of the aforementioned techniques and approaches aimed at understanding patterns within the user data and predicting future outcomes. Often, configuring the actionable activity is done so with motivation to educate the user. In some arrangements, at block 308, the one or more processing circuits can generate a plan associated with at least one different characteristic to cause an increase to the one or more performance indicators. Further, in some embodiments, the method at block 308 can configure a reward.

Still referring to FIG. 3 in more detail at block 308, the one or more processing circuits can, in response to determining an actionable activity associated with the at least one previous activity, configure the actionable activity corresponding to the at least one future activity of the user. Configuring the activity can take many forms. In some embodiments, the actionable activity is a future activity determine at block 306. For example, the statistical methods used at block 304 and block 306 can determine what the future activity and provide the details for the future activity. In some embodiments, at block 308, the circuits within the system (e.g., data control circuit 126, content control circuit 128) are configured to set activity details. The circuits configure the activity by writing instructions. For example, the circuits can predict all future billing events that are upcoming for the user across all of the cards, mortgages, loans, etc. even when the cards, mortgages, loans, etc. are serviced through different financial institutions. In some embodiments, the system can predict through adaptive learning that a customer will continue paying multiple credit card bills every month based on the customer having two auto-payments set up for credit cards as shown by credit close up data. Based on this prediction, the actionable activity can be an alert to the customer that they have credit card bills coming due before the bills are due even though the credit cards are all serviced through a different financial institution.

Still referring to FIG. 3 in more detail at block 308, in some embodiments, where there is a discrepancy or violation associated with the actionable activity based on a comparison between the user activity data or the performance indicators and a desired action for increasing the performance indicators, the comparison may identify an activity counter to the desired action. In some embodiments, at block 308 or 310, to remediate the discrepancy or violation, the system may configure and present an alert on the GUI comprising remediation instructions for the user. In some embodiments, the system, by the processing circuit via an application programming interface (API), may further establish a communication session with an external system associated with the activity counter to the desired action. In some embodiments, the communication session may update the external system to remove the activity counter to the desired action or initiate an exchange between an account of the user and the external system. For example, at block 308, the one or more processing circuit can determine a discrepancy or fraudulent previous activity via the statistical methods used to model the user activity data at block 304 and determining an update at block 306. Further, when a fraudulent action is determined, block 308 can configure the communication session to be presenting via an API at block 310 to ask the user what actions the user wants to take to remediate the fraudulent action. In some embodiments, the system, by the processing circuit, can then remove the fraudulent activity from the user data structure. In some embodiments, the method at block 308 can configure future exchange event to cause a change in the user data structure, and when selected, the future exchange event is automated.

Still referring to FIG. 3 in more detail at block 308, in some embodiments, the one or more processing circuits can configure the actionable activity as a bundled resource authorization. For example, through statistical analysis aforementioned, the configured activity could be bundling credit cards to decrease interest rates, determine rates across payment cards, determine a new rate, determine an introductory offer, estimate future events such as eliminating debt in a period of time.

Referring now to FIG. 3 in more detail at block 310, the one or more processors can generate and present a graphical user interface (GUI) including at least one actionable element and at least one message associated with the actionable activity. In some embodiments, the actionable element can relate to the actionable activity determined at block 308, in that the actionable element can carry out the actionable activity determined at block 308. In carrying out the actionable activity, the processors in the system can generate and present the GUI through a variety of means. In some embodiments, the method at block 310 can present the GUI through the operating system, display hardware, graphics rendering, windowing system, among other means. For example, the GUI system can incorporate event-driven programming, where actions or events trigger corresponding responses. In some embodiments, the operation system and applications of the devices used by the method can use implementations such as event handlers to update the GUI.

Still referring to FIG. 3 in more detail at block 310, the one or more processors can establish a communication session between the analysis system and other external systems or devices such as a user device. To establish a communication session via an application programming interface, the method at block 310 could establish connections through connection initiation, addressing and identification, handshake and negotiation, authentication and authorization, channel establishment, data exchange, or session maintenance. The exact process and protocols used to establish a communication session can vary depending on the specific devices, network infrastructure, and communication technologies involved. Different protocols, such as TCP/IP, Bluetooth, Wi-Fi, or specific application-layer protocols, have their own mechanisms for session establishment. Connection Initiation: The initiating device, often referred to as the client, sends a request to establish a connection with the target device, known as the server. This request can be initiated through various means, such as a physical cable connection, wireless signals, or network protocol. Addressing and identification involves the initiating device specifying the address or identifier of the target device it wishes to communicate with. This can be an IP address, domain name, MAC address, or any other unique identifier depending on the communication protocol being used. Handshake and negotiation involve the devices engaging in a handshake process to negotiate communication parameters and establish a common set of rules for the session. This includes agreeing on protocols, encryption methods, data formats, and other communication settings. Authentication and authorization involve the devices performing authentication and authorization procedures to ensure the identity and permissions of each other. This can involve exchanging credentials, digital certificates, or other security measures to validate the devices' authenticity and grant access to the requested resources. Channel establishment follows the process of once the handshake is successful and authentication is completed, the devices establish a communication channel. This can involve creating a logical connection, allocating network resources, or establishing a secure tunnel to facilitate data exchange. Data Exchange involves establishing a communication channel, and then allowing the devices to start exchanging data. This can involve sending messages, transmitting files, streaming media, or any other form of information exchange based on the intended purpose of the session. Session maintenance involves the devices periodically exchanging control messages to ensure the session remains active and monitor the connection's integrity during the communication session. This includes handling potential errors, retransmission of lost data, and managing any necessary protocol-specific maintenance tasks.

Still referring to FIG. 3 in more detail at block 310, the actionable element and messages can be comprehensive of many activities. In some embodiments, the actionable activity can relate to alerting the user of predicted future billing events. In some embodiments, the actionable activity can be an alert summarizing all of the customer's future activities, such as bill pay data, including upcoming and predicted bills, across all providers, such as financial institutions. The summary can be based on provider data (e.g., data from provider system 135) such as financial institutions without the financial institutions sharing data with the system. In some embodiments, the actionable activity can apply an automatic pay system, where the system can automatically pay a bill if the system has estimated the customer has a bill that is due but hasn't paid it yet. For example, the system can issue, via the GUI display means mentioned, an “automatic minimum payment alteration” by sending an alert to the customer to ask them if the system should make an automated minimum payment to the appropriate financial institution so that the customer pays the bills before it becomes late. If an exchange (e.g., bill) has been determined late, the system may generate an activity to enable or automatically set up a transaction process for a customer to pay a particular provider (e.g., creditor) based on determining the customer has missed an exchange (e.g., bill) to the provider based on monitoring the customer's user activity data. In some embodiments, the GUI could be presented in a calendar format to present to the customer when the system will notify the user of future activity or when the system will automatically configure the future events. In some arrangements, at block 310, the method can generate and present the GUI to update an automatic exchange event associated with the statement settlement to cause a non-negative account balance and configure a different statement settlement action to satisfy the difference between the non-negative account balance and the negative account balance.

Still referring to FIG. 3 in more detail at block 310, the method at block 310 may display an actionable activity and message dependent on if the actionable activity is above or below a threshold amount. For example, the system can present an overdraft warning or block a payment if the customer is likely to overdraft an account based on bills that are predicted to be due. In some embodiments, an actionable activity could also relate to resource allocation authorizations. For example, the system can allocate resources dependent on previous activities. For example, in response to a previous activity determined to be fraudulent, the GUI may present a message and generate and activity to challenge the previous activity. In some embodiments, the GUI may be generated for user satisfaction. For example, in some embodiments, the system can provide rewards to the user if it has previously detected that the user has over drafted accounts but has since stopped over drafting accounts.

For example, the system at block 310 can provide rewards via the GUI. In some embodiments, the reward can enable another feature of the GUI. For example, a reward can include informing the user they have gone a period of time without a discrepancy in their activity. In some embodiments, a reward could include a credit, reward points (e.g., credit card points), or other rewards.

### Cross-Provider User Activity Monitoring

As described herein, the analysis system 110 and/or a component thereof may receive user activity data pertaining to one or more users. The analysis system 110 may aggregate and/or accumulate the user activity data as the analysis system 110 receives the user activity data. For example, the analysis system 110 may store the user activity data in a database and/or registry. In some embodiments, the analysis system 110 may receive user activity data pertaining to a plurality of users. For example, the analysis system 110 may receive user activity data pertaining to a first user and a second user. The first user and the second user may be enrolled in a service provided by a first provider. For example, the first user and the second user may be enrolled in an account monitoring service.

In some embodiments, the analysis system 110 may provide the accumulated user activity data (e.g., the user activity data aggregated by the analysis system 110 as the analysis system 110 receives the user activity data) to a cross-provider user activity data monitoring system (e.g., the cross-provider system 175). The cross-provider user activity data monitoring system may analyze, review, compare, and/or otherwise examine the accumulated user activity data to identify one or more accounts pertaining to one or more users associated with the accumulated user activity. The one or more accounts may be accounts corresponding to the first provider (e.g., a provider implementing and/or providing the analysis system 110) and/or accounts corresponding to one or more second providers.

The cross-provider user activity data monitoring system may identify a first set of accounts of the one or more accounts that have a plurality of characteristics that exceed a predetermined threshold. For example, the predetermined threshold may be a difference between one or more terms of a default account (e.g., predetermined criteria) and one or more terms of the first set of accounts. To continue this example, the one or more terms of the default account may include a daily transaction amount, a daily number of transactions, a monthly withdrawal limit, and/or among various other possibilities.

The cross-provider user activity data monitoring system may utilize the accumulated user activity data to detect when at least one user of the plurality of users has at least one account, with the first provider and/or the one or more second providers, having terms that may be improved based on predetermined criteria. For example, a first user may have a first account with the one or more second providers and the first account may have X terms. To continue this example, the cross-provider user activity data monitoring system may determine that the first provider includes account services, similar to the first account, having Y terms. In some embodiments, the cross-provider user activity data monitoring system may determine that the Y terms include characteristics that exceed characteristics of the X terms. In some embodiments, the cross-provider user activity data monitoring system may determine that the X terms include characteristics that exceed characteristics of the Y terms.

In some embodiments, the predetermined criteria may refer to and/or include at least one of underwriting criteria, benchmark metrics, performance metrics, account criteria, applicant information specifications, and/or other evaluation guidelines. In some embodiments, the predetermined criteria may pertain to and/or be associated with a financial service and/or a financial product. For example, the predetermined criteria may include at least one of values for credit scores, values for debt-to-income ratios, values for monthly cashflow, values for yearly income, number of years in current job, home ownership, applicant age, total number of accounts for an applicant, existing customer, cosigners, values for various assets, savings, values for down payment amounts, and/or type of loan (e.g., mortgage, auto loan, recreational vehicle loan, real estate investment property, business loan, personal loan, credit card accounts, student loans, etc.).

The cross-provider system 175 includes processing circuit 410, dataset generator 425, account identifier 430, account adjustor 435, interface generator 440, and network interface 445. The processing circuit 410 may include components similar to that of the various processing circuits described herein. For example, the processing circuit 410 may include components similar to that of the processing circuit 114. The processing circuit 410 includes at least one processor 415 and memory 420. Memory 420 may be one or more devices (e.g., RAM, ROM, Flash memory, hard disk storage) for storing data and/or computer code for completing and/or facilitating the various processes described herein. Memory 420 may be or include non-transient volatile memory, non-volatile memory, and non-transitory computer storage media. Memory 420 may include database components, object code components, script components, or any other type of information structure for supporting the various activities and information structures described herein. Memory 420 may be communicably coupled to the processors 415 and include computer code or instructions for executing one or more processes described herein. The processors 415 may be implemented as one or more application specific integrated circuits (ASICs), field programmable gate arrays (FPGAs), a group of processing components, or other suitable electronic processing components. As such, the cross-provider system 175 is configured to run a variety of application programs and store associated data in a database of memory 420.

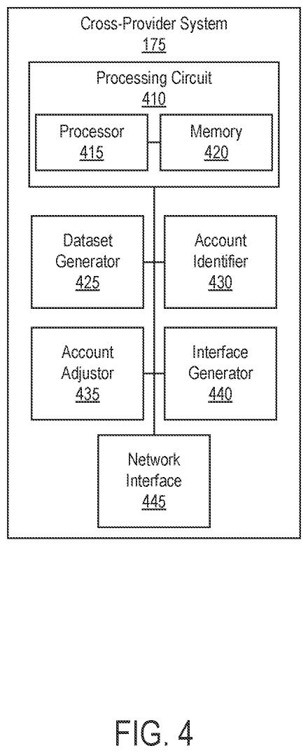

FIG. 4 depicts a block diagram of the cross-provider system 175 and/or cross-provider user activity data monitoring system 175, according to some embodiments. The cross-provider system 175 may include and/or be implemented as the cross-provider user activity data monitoring system described herein. In some embodiments, the cross-provider system 175 may include components similar to that of at least one of the systems described herein. For example, the cross-provider system 175 may include the I/O device 132. The cross-provider system 175 may be operated by and/or implemented by at least one of a provider, such as an entity, a consultant, a retailer, and/or a service provider. For example, the cross-provider system 175 may be operated by a financial institution. In some embodiments, the cross-provider system 175 may be included in, combined with, and/or implemented with the analysis system 110.

The network interface 445 may perform similar functionality to that of the network interface 112. For example, the network interface 445 may facilitate communications between devices of a network. The network interface 445 may be implemented with and/or provided with the network interface 112. The network interface 445 may include components similar to that of the network interface 112.

The cross-provider system 175 may obtain user activity data pertaining to a plurality of user enrolled in a service provided by a first provider. For example, the cross-provider system 175 may receive user activity data accumulated by the analysis system 110. In some embodiments, the cross-provider system 175 may obtain the user activity data in a continuous and/or semi-continuous stream. For example, the analysis system 110 may receive the user activity data and the analysis system 110 may then forward and/or provide the user activity data to the cross-provider system 175.

In some embodiments, the service provided by the first provider may include at least one of account management services, transaction monitoring services, consolidation services, deferment services, and/or among various other possible services. For example, the service provided by the first provider may include monitoring transactions of a given account to identify various rebates associated with one or more retailers corresponding to one or more transactions.

The account identifier 430 may identify, based on information included in the user activity data, a plurality of accounts. For example, the account identifier 430 may identify a first plurality of accounts for which one or more first users of a plurality of users have with a first provider and a second plurality of accounts for which one or more second users of the plurality of users have with one or more second providers. The account identifier 430 may identify the plurality of accounts by at least one of extracting, detecting, examining, and/or otherwise analyzing the user activity data to identify the plurality of accounts. For example, the account identifier 430 may extract from one or more statements included in the user activity data the first provider and the one or more second providers.

The dataset generator 425 may generate, based on information associated with at least one the first plurality of accounts or the second plurality of accounts, a plurality of datasets corresponding to information associated with at least one of the first provider or the one or more second providers. For example, the dataset generator 425 may generate one or more first datasets pertaining to accounts associated with the first provider and one or more second datasets pertaining to accounts associated with the one or more second providers. The one or more first datasets may be organized and/or otherwise sorted based on characteristics of the one or more accounts. For example, the first dataset may include a plurality of segments corresponding to given account types. To continue this example, a first segment of the plurality of segments may correspond to home mortgage accounts (e.g., an account type) and second segment of the plurality of segments may correspond to checking accounts (e.g., an account type). In some embodiments, the dataset generator 425 may generate the plurality of datasets by generating a first plurality of datasets corresponding to information associated with the first provider and generating a second plurality of datasets corresponding to information associated with the one or more second providers.

The account identifier 430 may identify, responsive to evaluation of the plurality of datasets based on predetermined criteria, a first set of accounts of at least one of the first plurality of accounts or the second plurality of accounts that exceed a predetermined threshold and a second set of accounts of at least one of the first plurality of accounts or the second plurality of accounts within the predetermined threshold. For example, the account identifier 430 may identify accounts included in the first segment that have mortgage interest rates larger than a given interest rate (e.g., a predetermined criteria) by a given amount (e.g., a predetermined threshold). To continue this example, the account identifier 430 may also identify accounts that have mortgage interest rates that are less than the interest rate. In some embodiments, evaluation of the plurality of datasets based on predetermined criteria may include the first plurality of datasets with the second plurality of datasets based on a plurality of performance indicators associated with at least one user of the plurality of users.

The account adjustor 435 may generate, based on characteristics of the first set of accounts or characteristics of the second set of accounts, a plurality of changes to the predetermined criteria to adjust at least one of a number of accounts included in the first set of accounts or a number of accounts included in the second set of accounts. For example, the account adjustor 435 may generate changes to the given interest rate. In this example, the changes to the given interest rate may include adjusting an amount of the given interest rate.

In some embodiments, the plurality of changes to the predetermined criteria may include adjusting account terms (e.g., interest rates associated with checking accounts, repayment periods for credit card transactions, daily transactions amounts, etc.). For example, the plurality of changes to the predetermined criteria may include changing a repayment period for credit card purchases from 30 days to 45 days. In some embodiments, the plurality of changes to the predetermined criteria may provide a given provider, associated with the cross-provider system 175 (e.g., a provider that is implementing the cross-provider system 175), with the ability to adjust, change, improve, enhance, and/or otherwise modify services provided by the given provider. For example, the given provider may have a first user enrolled in a service with the given provider, however the first user may also have a first account associated with a second provider. The first user may have the first account with the second provider responsive to the second provider having advantageous terms. In this example, the given provider may utilize the cross-provider system 175 to detect the first account with the second provider and the given provider may modify account terms for accounts similar to the first account based on the advantageous terms of the first account.

The interface generator 440 may generate and present a graphical user interface (GUI) including a plurality of elements to indicate the plurality of changes. For example, the cross-provider system 175 may include and/or be in communication with a monitor (e.g., I/O device 132) and the interface generator 440 may transmit signals to the monitor that causes the monitor to display and/or otherwise present the GUI. The plurality of elements may include at least one of icons, graphical displays, windows, text boxes, tabs, and/or other possible GUI elements. The plurality of elements may be selectable. For example, the monitor may include a touch screen and the monitor may display the GUI. To continue this example, a user interacting with the monitor may select and/or otherwise interact with the plurality of elements (e.g., touch at least one element).

The interface generator 440 may receive, via the GUI, a selection of a first element of the plurality of elements corresponding to a first change of the plurality of changes. For example, one or more elements of the plurality of elements may represent and/or otherwise be associated with one or more changes of the plurality of changes. To continue this example, a first element of the plurality of elements may be associated with a first change of the plurality of changes.

The account adjustor 435 may update, responsive to receiving the selection, the predetermined criteria to reflect the first change of the plurality of changes. For example, the first change may include changing, from a first value to a second value, a number of daily transactions (e.g., a predetermined criteria) that may occur for one or more accounts without a fee. In this example, the account adjustor 435 may update the predetermined criteria (e.g., number of daily transactions) from the first value to a second value. As another example, the predetermined criteria may include a statement balance amount and the change to the statement balance amount may include changing the statement balance amount from a first value to a second value.

The cross-provider system 175 may obtain, responsive to updating the predetermined criteria, second user activity data pertaining to the plurality of users. For example, the cross-provider system 175 may receive user activity data corresponding to information that was collected and/or generated after the predetermined criteria was updated. In some embodiments, the cross-provider system 175 may receive the second user activity data prior to any change to the predetermined criteria.

The cross-provider system 175 may identify, based on the second user activity data, one or more changes to at least one of the first plurality of accounts or the second plurality of accounts. For example, the cross-provider system 175 may determine that a first given account included in the first plurality of accounts was closed by a first user and that the first user also opened a second account. In some embodiments, the second account may be included in the first plurality of accounts or the second plurality of accounts. In some embodiments, the cross-provider system 175 analyzes the changes to the first plurality of accounts and the second plurality of accounts to determine an impact that updating the predetermined criteria had on user activity data. For example, the change in the predetermined criteria may include reducing an interest rate for vehicle purchases corresponding to a given vehicle make and the cross-provider system 175 may analyze one or more vehicle loan accounts corresponding to a vehicle of the given vehicle make to detect one or more changes to vehicle loan accounts.

The cross-provider system 175 may update, using the one or more changes, the first set of accounts and the second set of accounts. For example, the cross-provider system 175 may remove a first account from at least one of the first set of accounts or the second set of accounts. As another example, the computing system may add a second account to at least one of the first set of accounts or the second set of accounts. The cross-provider system 175 may update the first set of accounts and the second set of accounts to reflect changes to the accounts. For example, if a first user closed a first account included in the second set of accounts and then opened a second account that would qualify for inclusion in the first set of accounts, the cross-provider system 175 may remove the first account from the second set of accounts and add the second account to the first set of accounts.

The cross-provider system 175 may obtain second user activity data to indicate one or more subsequent accounts pertaining to the plurality of users. In some embodiments, the second user activity data may include information corresponding to one or more events that occurred after an update to the predetermined criteria. For example, the one or more subsequent accounts may include accounts that were opened, closed, modified and/or adjusted subsequent to the predetermined criteria having been changed. The one or more events may include a user closing a first account, the user opening a second account, the user adjusting characteristics of a third account, and/or among various other possibilities.

The cross-provider system 175 may detect, based on the information corresponding to the one or more events, a change to second predetermined criteria pertaining to the one or more second providers. For example, the cross-provider system 175 may monitor, review, and/or otherwise watch predetermined criteria, that dataset generator 425 extracted from the user activity data, pertaining to the one or more second providers to detect changes to the predetermined criteria. For example, the dataset generator 425 may determine overdraft fees for accounts provided by the one or more second providers and the cross-provider system 175 may detect a change to the overdraft fees responsive to detecting that the overdraft fees amount has changed.

The account adjustor 435 may update the plurality of changes to include at least one change that reflects the change to the second predetermined criteria. For example, the account adjustor 435 may update the plurality of changes to include changes to predetermined criteria similar to the second predetermined criteria. As another example, the change to the second predetermined criteria may include adjusting a monthly minimum account balance from a first value to a second value. In this example, the account adjustor 435 may update the plurality of changes to include at least one change that reflects the second value.

The interface generator 440 may update at least one element of the plurality of elements to reflect the update for the at least one change of the plurality of changes. For example, the interface generator 440 may update an element that corresponds to interest rates pertaining to car loans from a first value to a second value. To continue this example, the second value may reflect the update for the at least one change (e.g., interest rates pertaining to car loans where changed).

The cross-provider system 175 may identify, based on the first set of accounts and the second set of accounts, a first user of the plurality of users having a first account included in the first set of accounts and a second account included in the second set of accounts. For example, the cross-provider system 175 may identify that a first user has a checking account included in the first set of accounts and that the first user also has a mortgage account included in the second set of accounts.

The cross-provider system 175 may determine, based on information associated with the first user, that a provider system (e.g., provider system 135, computing system, etc.) associated with the first provider declined a first request for the first account. For example, the cross-provider system 175 may determine that the user provided a request for a mortgage account (e.g., a first account) with the first provider and that the request was declined. To continue this example, the cross-provider system 175 may also determine that the user provided a second request for the mortgage account with a second provider and that the request was approved.

The cross-provider system 175 may monitor, responsive to determining that the computing declined the first request, the first account to detect one or more changes to the first account. For example, the cross-provider system 175 may monitor the first account to detect that after two months that the user associated with the first account switched a default payment amount from a minimum payment amount to a statement balance amount.

The cross-provider system 175 may determine, responsive to detecting the one or more changes to the first account, a performance of the first account with respect to second predetermined criteria. For example, the cross-provider system 175 may determine the performance of the first account with respect to a number of late payments (e.g., second predetermined criteria). As another example, the cross-provider system 175 may determine the performance of the first account with respect to a number of months where a balance was carried over for a credit card account.

The cross-provider system 175 may detect, based on the performance of the first account, that the performance of the first account exceeds performance of one or more second accounts included in the second set of accounts. For example, the cross-provider system 175 may detect that the first account includes a first given number of late payments and that the one or more second accounts include a second given number of late payments larger than the first given amount. In this example, the first given number of late payments (e.g., performance of the first account) exceeds the performance (e.g., the second given number of late payments) of the one or more second accounts.

The account adjustor 435 may generate one or more updates to the plurality of changes to reflect characteristics pertaining to at least one of the first user or the first account. For example, the request of the user for the first account with the first provider may have been declined for specific reasons and the account adjustor 435 may generate updates to the plurality of changes to include characteristics of the first user or the first account.

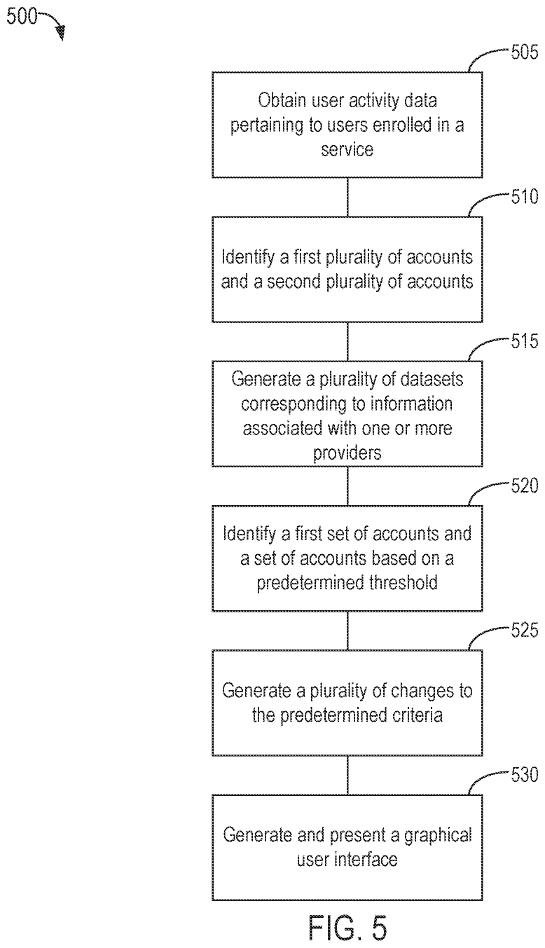

FIG. 5 depicts a flow diagram of a method 500 of monitoring cross-provider user activity data, according to some embodiments. In some embodiments, the cross-provider system 175 may perform at least one step of the method 500. In some embodiments, a component of the cross-provider system 175 may perform at least one step. For example, the interface generator 440 may perform at least one step of the method 500. In some embodiments, any computing device described herein may perform at least one step of the method 500. For example, the analysis system 110 may perform at least one step of the method 500.

At step 505, user activity data pertaining to a user enrolled in a service may be obtained. For example, the cross-provider system 175 may obtain user activity data pertaining to the plurality of users described herein. In some embodiments, the service may include at least one of the various services described herein. The cross-provider system 175 may obtain the user activity data responsive to the user enrolling in the service.

In some embodiments, the cross-provider system 175 may obtain the user activity data at given increments and/or at given points in time. For example, the cross-provider system 175 may receive the user activity data at the beginning a given month (e.g., a first day of a month). The cross-provider system 175 may also obtain the user activity data responsive to changes in the user activity data. For example, the cross-provider system 175 may receive user activity data responsive to a given user opening a credit card account.

At step 510, a first plurality of accounts and a second plurality of accounts may be identified. For example, the account identifier 430 may identify the first plurality of accounts and the second plurality of accounts based on the user activity data received in step 505. In some embodiments, the account identifier 430 may identify one or more accounts associated with a first provider and one or more accounts associated with one or more second accounts.

In some embodiments, the account identifier 430 may identify accounts as the user activity data is received. For example, the user activity data may be obtained in portions and as a given portion is obtained, the account identifier 430 may identify accounts associated with the given portion.

At step 515, a plurality of datasets corresponding to information associated with one or more providers may be generated. For example, the dataset generator 425 may generate the plurality of datasets that correspond to information associated with the first provider and/or the one or more second providers. In some embodiments, the dataset generator 425 may generate the plurality of datasets by grouping, organizing, and/or otherwise sorting the plurality of datasets in segments based on account types. For example, the plurality of datasets may include a first segment corresponding to vehicle loan accounts and a second segment corresponding to credit card accounts.

At step 520, a first set of accounts and a second set of accounts may be identified based on a predetermined threshold. For example, the account identifier 430 may identify the first set of accounts given that the first set of accounts exceed the predetermined threshold. As another example, the account identifier 430 may identify the second set of accounts given that the second set of accounts are within the predetermined threshold. In some embodiments, account identifier 430 may identify the first set of accounts and the second set of accounts by analyzing the segments included in the plurality of datasets. The account identifier 430 analyzing the segments may allow for the cross-provider system 175 to peer review accounts (e.g., mortgage accounts are compared to one another, car loan accounts are compared to one another, etc.).

At step 525, a plurality of changes to the predetermined criteria may be generated. For example, the account adjustor 435 may generate the plurality of changes to adjust at least one of a number of accounts included in the first set of accounts or a number of accounts included in the second set of accounts. To continue this example, the account adjustor 435 may adjust the number of accounts by adjusting the predetermined criteria to a given value, a given setpoint, a given amount, a given factor, etc. such that an account that exceeded the predetermined threshold, prior to a change to the predetermined criteria, would no longer exceed the predetermined threshold. As another example, adjusting the predetermined criteria may cause an account that was previously within the predetermined threshold, prior to a change in the predetermined criteria, to no longer be within the predetermined threshold.

In some embodiments, the account adjustor 435 may determine criteria pertaining to one or more providers. For example, the account adjustor 435 may determine underwriting criteria for a first bank (e.g., a first provider) and a second back (e.g., a second provider). To continue this example, the account adjustor 435 may compare the underwriting criteria of at least one of the first bank and/or the second bank with underwriting criteria for a third provider. The account adjustor 435 may identify differences between the underwriting criteria. For example, the account adjustor 435 may identify that the first bank is approving personal loans for X amount when the applicant (e.g., customer) has a debt-to-income ratio of Y. To continue this example, the account adjustor 435 may identify that the third provider is approving personal loans for X amount when the applicant has a debt-to-income ratio of Z.

In some embodiments, the account adjustor 435 may generate a plurality of changes for one or more predetermined criteria. For example, the account adjustor 435 may generate changes for the underwriting criteria for the third provider responsive to the account adjustor 435 determining that the third provider's underwriting criteria is eliminated otherwise qualified applicants. Stated otherwise, the account adjustor 435 may generate changes for underwriting criteria responsive to the account adjustor 435 determining that the underwriting criteria is restrictive and/or lenient.

In some embodiments, the account adjustor 435 may generate changes for the predetermined criteria based on and/or using a predetermined threshold. For example, a provider hosting and/or utilizing the cross-provider system 175 may establish a threshold (e.g., a difference between criteria). In some embodiments, the predetermined threshold may be a percentage, a percent difference, an absolute value, a mathematical difference, and/or a range. For example, the provider may establish a predetermined threshold of 5% with respect to credit card interest rates. To continue this example, the account adjustor 435 may determine that a subsequent provider (e.g., a different provider) is offering an interest rate C percent for customers that have a yearly income of K amount. Furthermore, in this example, the account adjustor 435 may generate changes to the underwriting criteria for the provider. As an example, the account adjustor 435 may generate, based on the predetermined threshold of 5%, changes to the underwriting criteria such that the yearly income requirement for the provider is within 5% of the K amount.

As a non-limiting example, the K amount may be $100,000 (U.S. Dollars) in yearly income and the C percent may be 10%. To continue this non-limiting example, the provider hosting the cross-provider system 175 may have a yearly income requirement (e.g., underwriting criteria) of $110,000 (U.S. Dollars) in yearly income to offer a credit card with an interest rate of 10%. In this non-limiting example, the account adjustor 435 may generate changes to the underwriting criteria for the provider. To continue this non-limiting example, the account adjustor 435 may change the yearly income amount from $110,000 to $102,000. In this non-limiting example, the account adjustor 435 generating a change (e.g., changing the yearly income amount from $110,000 to $102,000) to the underwriting criteria satisfies the predetermine threshold of 5%.

At step 530 a graphical user interface (GUI) may be generated and presented. For example, the interface generator 440 may generate a user interface and the interface generator 440 may provide signals, to a monitor (e.g., I/O device 132), that cause the monitor to display the user interface via the GUI. The GUI may include a plurality of elements to indicate the plurality of changes generated in step 525.

### Configuration of Exemplary Embodiments

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions and arrangement of the embodiments without departing from the scope of the present disclosure as expressed in the appended claims.

What is claimed is:

1. A method, comprising:
obtaining, by one or more processing circuits, user activity data pertaining to a plurality of users enrolled in a service provided by a first provider;
identifying, by the one or more processing circuits based on information included in the user activity data, a first plurality of accounts for which one or more first users of the plurality of users have with the first provider, and a second plurality of accounts for which one or more second users of the plurality of users have with one or more second providers;
generating, by the one or more processing circuits based on information associated with at least one of the first plurality of accounts or the second plurality of accounts, a plurality of datasets corresponding to information associated with at least one of the first provider or the one or more second providers;
identifying, by the one or more processing circuits responsive to an evaluation of the plurality of datasets based on predetermined criteria, a first set of accounts of at least one of the first plurality of accounts or the second plurality of accounts that exceed a predetermined threshold, and a second set of accounts of at least one of the first plurality of accounts or the second plurality of accounts within the predetermined threshold;
generating, by the one or more processing circuits based on characteristics of the first set of accounts or characteristics of the second set of accounts, a plurality of changes to the predetermined criteria to adjust at least one of a number of accounts included in the first set of accounts or a number of accounts included in the second set of accounts; and
generating and presenting, by the one or more processing circuits, a graphical user interface (GUI) including a plurality of elements to indicate the plurality of changes.

2. The method of claim 1, further comprising:
receiving, by the one or more processing circuits via the GUI, a selection of a first element of the plurality of elements corresponding to a first change of the plurality of changes; and
updating, by the one or more processing circuits responsive to receiving the selection, the predetermined criteria to reflect the first change of the plurality of changes.

3. The method of claim 2, further comprising:
obtaining, by the one or more processing circuits responsive to updating the predetermined criteria, second user activity data pertaining to the plurality of users;
identifying, by the one or more processing circuits based on the second user activity data, one or more changes to at least one of the first plurality of accounts or the second plurality of accounts; and
updating, by the one or more processing circuits using the one or more changes, the first set of accounts and the second set of accounts.

4. The method of claim 3, wherein updating, by the one or more processing circuits using the one or more changes, the first set of accounts and the second set of accounts includes at least one of removing a first account from at least one of the first set of accounts or the second set of accounts, or adding a second account to at least one of the first set of accounts or the second set of accounts.

5. The method of claim 1, further comprising:
obtaining, by the one or more processing circuits, second user activity data to indicate one or more subsequent accounts pertaining to the plurality of users, the second user activity data including information corresponding to one or more events that occurred after an update to the predetermined criteria;
detecting, by the one or more processing circuits based on the information corresponding to the one or more events, a change to second predetermined criteria pertaining to the one or more second providers; and
updating, by the one or more processing circuits, the plurality of changes to include at least one change that reflects the change to the second predetermined criteria.

6. The method of claim 1, wherein generating the plurality of datasets includes:
generating, by the one or more processing circuits based on information associated with the first plurality of accounts, a first plurality of datasets corresponding to information associated with the first provider; and
generating, by the one or more processing circuits based on information associated with the second plurality of accounts, a second plurality of datasets corresponding to information associated with the one or more second providers.

7. The method of claim 6, wherein the evaluation of the plurality of datasets includes:
comparing, by the one or more processing circuits, the first plurality of datasets with the second plurality of datasets based on a plurality of performance indicators associated with at least one user of the plurality of users.

8. The method of claim 1, further comprising:
identifying, by the one or more processing circuits based on the first set of accounts and the second set of accounts, a first user of the plurality of users having a first account included in the first set of accounts and a second account included in the second set of accounts;
determining, by the or more processing circuits based on information associated with the first user, that a computing system associated with the first provider declined a first request for the first account; and
monitoring, by the one or more processing circuits responsive to determining that the computing system declined the first request, the first account to detect one or more changes to the first account.

9. The method of claim 8, further comprising:
determining, by the one or more processing circuits responsive to detecting the one or more changes to the first account, a performance of the first account with respect to second predetermined criteria;
detecting, by the or more processing circuits based on the performance of the first account, that the performance of the first account exceeds a performance of one or more second accounts included in the second set of accounts; and
generating, by the one or more processing circuits, one or more updates to the plurality of changes to reflect characteristics pertaining to at least one of the first user or the first account.

10. The method of claim 1, further comprising:
detecting, by the one or more processing circuits based on second user activity data to indicate one or more changes to the second plurality of accounts, a change to second predetermined criteria pertaining to the one or more second providers;
generating, by the one or more processing circuits respective to detecting the change to the second predetermined criteria, an update for at least one change of the plurality of changes; and
updating, by the one or more processing circuits, at least one element of the plurality of elements to reflect the update for the at least one change of the plurality of changes.

11. A computing system, comprising:
a processing circuit comprising one or more memory devices and one or more processors, the processing circuit configured to:
obtain user activity data pertaining to a plurality of users enrolled in a service provided by a first provider;
identify, based on information included in the user activity data, a first plurality of accounts for which one or more first users of the plurality of users have with the first provider, and a second plurality of accounts for which one or more second users of the plurality of users have with one or more second providers;
generate, based on information associated with at least one of the first plurality of accounts or the second plurality of accounts, a plurality of datasets corresponding to information associated with at least one of the first provider or the one or more second providers;
identify, responsive to an evaluation of the plurality of datasets based on predetermined criteria, a first set of accounts of at least one of the first plurality of accounts or the second plurality of accounts that exceed a predetermined threshold, and a second set of accounts of at least one of the first plurality of accounts or the second plurality of accounts within the predetermined threshold;
generate, based on characteristics of the first set of accounts or characteristics of the second set of accounts, a plurality of changes to the predetermined criteria to adjust at least one of a number of accounts included in the first set of accounts or a number of accounts included in the second set of accounts; and
generate and present a graphical user interface (GUI) including a plurality of elements to indicate the plurality of changes.

12. The computing system of claim 11, wherein the processing circuit is further configured to:
receive, via the GUI, a selection of a first element of the plurality of elements corresponding to a first change of the plurality of changes; and
update, responsive to receipt of the selection, the predetermined criteria to reflect the first change of the plurality of changes.

13. The computing system of claim 12, wherein the processing circuit is further configured to:
obtain, responsive to updating the predetermined criteria, second user activity data pertaining to the plurality of users;
identify, based on the second user activity data, one or more changes to at least one of the first plurality of accounts or the second plurality of accounts; and
update, using the one or more changes, the first set of accounts and the second set of accounts.

14. The computing system of claim 13, wherein the processing circuit is configured to update the first set of accounts and the second set of accounts by at least one of removing a first account from at least one of the first set of accounts or the second set of accounts, or adding a second account to at least one of the first set of accounts or the second set of accounts.

15. The computing system of claim 11, wherein the processing circuit is further configured to:
obtain second user activity data to indicate one or more subsequent accounts pertaining to the plurality of users, the second user activity data including information corresponding to one or more events that occurred after an update to the predetermined criteria;
detect, based on the information corresponding to the one or more events, a change to second predetermined criteria pertaining to the one or more second providers; and
update the plurality of changes to include at least one change that reflects the change to the second predetermined criteria.

16. The computing system of claim 11, wherein the processing circuit is configured to generate the plurality of datasets by:
generating, based on information associated with the first plurality of accounts, a first plurality of datasets corresponding to information associated with the first provider; and
generating, based on information associated with the second plurality of accounts, a second plurality of datasets corresponding to information associated with the one or more second providers.

17. A non-transitory computer-readable storage medium (CRM) having instructions stored thereon that, when executed by a processing circuit comprising one or more processors, cause the processing circuit to perform operations comprising:
obtaining user activity data pertaining to a plurality of users enrolled in a service provided by a first provider;
identifying, based on information included in the user activity data, a first plurality of accounts for which one or more first users of the plurality of users have with the first provider, and a second plurality of accounts for which one or more second users of the plurality of users have with one or more second providers;
generating, based on information associated with at least one of the first plurality of accounts or the second plurality of accounts, a plurality of datasets corresponding to information associated with at least one of the first provider or the one or more second providers;
identifying, responsive to an evaluation of the plurality of datasets based on predetermined criteria, a first set of accounts of at least one of the first plurality of accounts or the second plurality of accounts that exceed a predetermined threshold, and a second set of accounts of at least one of the first plurality of accounts or the second plurality of accounts within the predetermined threshold;
generating, based on characteristics of the first set of accounts or characteristics of the second set of accounts, a plurality of changes to the predetermined criteria to adjust at least one of a number of accounts included in the first set of accounts or a number of accounts included in the second set of accounts; and
generating and presenting a graphical user interface (GUI) including a plurality of elements to indicate the plurality of changes.

18. The CRM of claim 17, wherein the operations further comprise:
receiving, via the GUI, a selection of a first element of the plurality of elements corresponding to a first change of the plurality of changes; and
updating, responsive to receiving the selection, the predetermined criteria to reflect the first change of the plurality of changes.

19. The CRM of claim 18, wherein the operations further comprise:
obtaining, responsive to updating the predetermined criteria, second user activity data pertaining to the plurality of users;
identifying, based on the second user activity data, one or more changes to at least one of the first plurality of accounts or the second plurality of accounts; and
updating, using the one or more changes, the first set of accounts and the second set of accounts.

20. The CRM of claim 19, wherein updating, using the one or more changes, the first set of accounts and the second set of accounts includes at least one of removing a first account from at least one of the first set of accounts or the second set of accounts or adding a second account to at least one of the first set of accounts or the second set of accounts.
